(19) United States
(12) Patent Application Publication
(10) Pub. No.: US 2026/0002636 A1
(43) Pub. Date: Jan. 1, 2026

(54) GOLF CART SUPPORT FOR BALL WASHING DEVICE

(71) Applicant: Serge BOUTHILLIER, St Joseph du lac (CA)

(72) Inventor: Serge BOUTHILLIER, St Joseph du lac (CA)

(21) Appl. No.: 19/251,059

(22) Filed: Jun. 26, 2025

Related U.S. Application Data
(60) Provisional application No. 63/664,556, filed on Jun. 26, 2024.
(60) Provisional application No. 63/754,195, filed on Feb. 5, 2025.

(51) Int. Cl. F16M 13/02; A63B 47/04; A63B 55/00; F16M 11/04; F16M 11/08; F16M 11/20

(52) U.S. Cl. CPC F16M 13/022; A63B 47/04; A63B 55/408; F16M 11/046; F16M 11/08; F16M 11/2057

(57) ABSTRACT

A support for attaching a golf ball washing device to a golf trolley supporting a golf bag, has: a fastening member configured for being removably secured to a frame member of the golf trolley or to the golf bag; a device holder configured for supporting the golf ball washing device; and a positioning mechanism operatively connected to both of the device holder and the fastening member, the positioning mechanism including arms pivotably engaged to one another and operable to move the device holder relative to the fastening member about a plurality of degrees of freedom.

### TECHNICAL FIELD

The application relates generally to golfing equipment and, more particularly, to systems and methods to carry a ball washing device on a golf cart.

### BACKGROUND

Golf ball washing devices are used by golfers to maintain cleanliness and performance of golf balls during play. Various designs have been developed over the years to address this need. However, existing golf ball washing device are usually immobile appliances that cannot be moved with the golfer. Although satisfactory to some extent, there is always room for improvements, notably because golf ball washing devices are less available than before pursuant to a change in sanitary standards.

### SUMMARY

In one aspect, there is provided a support for attaching a golf ball washing device to a golf trolley supporting a golf bag, comprising: a fastening member configured for being removably secured to a frame member of the golf trolley or to the golf bag; a device holder configured for supporting the golf ball washing device; and a positioning mechanism operatively connected to both of the device holder and the fastening member, the positioning mechanism including arms pivotably engaged to one another and operable to move the device holder relative to the fastening member about a plurality of degrees of freedom.

The support described above may include any of the following features, in any combinations.

In some embodiments, the arms include: a first arm extending from a first proximal end pivotably mounted to the fastening member to a first distal end; a second arm extending from a second proximal end pivotably mounted to the first distal end of the first arm to a second distal end mounted to the device holder.

In some embodiments, the fastening member extends around a longitudinal axis being parallel to the frame member.

In some embodiments, the first proximal end is rotatable relative to the fastening member about a first axis being transverse to the longitudinal axis.

In some embodiments, the support includes a first anti-rotation feature between the first proximal end and the fastening member to selectively prevent rotation between the first arm and the fastening member.

In some embodiments, the second proximal end of the second arm is rotatable relative to the first distal end of the first arm about a second axis being transverse to both of the first arm and the second arm to vary an angle defined between the first arm and the second arm.

In some embodiments, the support includes a second anti-rotation feature between the first distal end and the second proximal end to selectively prevent rotation between the first arm and the second arm about the second axis.

In some embodiments, the first arm has a first arm section and a second arm section mounted coaxially to the first arm section, the first arm section rotatable relative to the second arm section.

In some embodiments, the device holder includes a support plate having a support flange extending peripherally around an aperture sized to receive the golf ball washing device therethrough.

In some embodiments, the fastening member includes a vertical tab receivable within an opening of the golf bag.

In some embodiments, the arms include a first plate and a second plate pivotally engaged to the first plate for rotation about a roll axis, the second plate pivotally engaged to the device holder for rotation about a pitch axis transverse to the roll axis.

In some embodiments, the fastening member is a strap extending around the golf bag, the device holder secured to the golf bag via the strap.

In some embodiments, the strap is received through slots defined by device holder.

In one aspect, there is provided an assembly comprising: a golf ball washing device having a container enclosing bristles for washing a golf ball; and a support for securing the golf ball washing device to a golf trolley or a golf bag, the support having: a fastening member configured for being removably secured to a frame member of the golf trolley or to the golf bag; a device holder configured for supporting the golf ball washing device; and a positioning mechanism operatively connected to both of the device holder and the fastening member, the positioning mechanism including arms pivotably engaged to one another and operable to move the device holder relative to the fastening member about a plurality of degrees of freedom; and a locking mechanism for releasably securing the golf ball washing device to the device holder, the locking mechanism having a male member defined by one of the container of the golf ball washing device and the device holder of the support and a female member defined by the other of the container of the golf ball washing device and the device holder of the support, the locking mechanism having a locked configuration in which the male member engages and is locked into the female member and an unlocked configuration in which the male member is detachable from the female member.

The assembly described above may include any of the following features, in any combinations.

In some embodiments, the male member includes tabs receivable within slots of the male member, the slots having open sections and closed sections, the tabs receivable into the slots via the open sections via an axial translation of the golf ball washing device relative to the device holder, the tabs slidably receivable into the closed sections of the slots via rotation of the golf ball washing device relative to the device holder.

In some embodiments, the assembly includes a locking device to lock the locking mechanism in the locked configuration, the locking device including a latch pivotally mounted to the device holder, the latch having a locking end receivable into a notch defied by the golf ball washing device, wherein the locking end of the latch is in register with the notch upon the tabs received into the closed sections of the slots.

In some embodiments, the assembly further includes a ball holding device having: a handle defining an aperture; and a movable flap pivotally engaged to the handle, the movable flap movable between a ball-holding position in which the movable flap is received in the aperture and a ball-releasing position in which the movable flap is pivoted away from the aperture, the ball holding device configured to at least partially enclose the golf ball in the ball-holding position.

In some embodiments, both of the handle and the movable flap defines tabs for holding the golf ball.

In some embodiments, the assembly further includes a latch for locking the movable flap relative to the handle in the ball-holding position.

In some embodiments, the assembly includes a retractable rope, the golf ball washing device secured to the golf ball washing device or the support via the retractable rope.

### DESCRIPTION OF THE DRAWINGS

Reference is now made to the accompanying figures in which:

FIG. 1 is a three dimensional view of a golf bag supported on a golf cart being equipped with a ball washing device;

FIG. 2 is a three dimensional view illustrating a support for supporting the golf ball washing device;

FIG. 3 is an exploded three dimensional view of the support of FIG. 2;

FIG. 4 is a cross-sectional view taken along line 4-4 on FIG. 6;

FIG. 5 is a cross-sectional view taken along line 5-5 on FIG. 6;

FIG. 6 is a front three dimensional view of the support of FIG. 2;

FIG. 7A is a three dimensional view of a golf bag supported on a golf cart, the golf bag being equipped with a ball washing device using a support in accordance with another embodiment, the support being installed in a first location on the golf bag;

FIG. 7B is a three dimensional view illustrating the support of FIG. 7A being installed in a second location on the golf bag;

FIG. 8 is a three dimensional view of the support of FIG. 7A with the ball washing device mounted thereto;

FIG. 9 is a three dimensional exploded view of the support of FIG. 7A;

FIG. 10 is a front view of the support of FIG. 7A illustrating different configurations;

FIGS. 11A and 11B are three dimensional views of the support of FIG. 7A illustrated in two configurations;

FIGS. 12A and 12B are side views of the support of FIG. 7A illustrating other possible configurations;

FIG. 13 is a three dimensional view of a golf bag supported on a golf cart, the golf bag being equipped with a ball washing device using a support in accordance with another embodiment, the support being installed in a first location on the golf bag;

FIG. 14 is a three dimensional view of the ball washing device and support of FIG. 13;

FIG. 15 is a three dimensional exploded view of the support and ball washing device of FIG. 13;

FIG. 16 is a cross-sectional view taken along line 16-16 on FIG. 14;

FIGS. 17A and 17B are three dimensional views of golf bag supported on a golf cart, the golf bag being equipped with a ball washing device using a support in accordance with another embodiment, the support being installed in a first location (FIG. 17A) and in a second location (FIG. 17B) on the golf bag;

FIG. 18 is a three dimensional exploded view of the support and of the ball washing device of FIG. 17A;

FIG. 19 is a three dimensional view of the support of FIG. 17A with the ball washing device illustrated in a transportation position;

FIG. 20 is a three dimensional view of the support of FIG. 17A with the ball washing device illustrated in an operational position;

FIG. 21 is a cross-sectional view taken along line 21-21 on FIG. 19;

FIGS. 22A and 22B are cutaway views of the ball washing device of FIG. 17A taken along line 22A-22A on FIG. 21 illustrating a locked (FIG. 22A) and unlocked (FIG. 22B) position of the ball washing device on the support;

FIG. 22C is a cross-sectional view taken along line 22C-22C on FIG. 22A;

FIG. 22D is a cross-sectional view taken along line 22D-22D on FIG. 22B;

FIG. 23 is a three dimensional view of a ball support of the ball washing device of FIG. 17A:

FIG. 24 is a three dimensional exploded view of the ball support of FIG. 23;

FIG. 25 is a cross-sectional view of the ball support taken along line 25-25 on FIG. 23; and

FIG. 26 is a cross-sectional view of the ball support taken along line 26-26 on FIG. 23.

### DETAILED DESCRIPTION

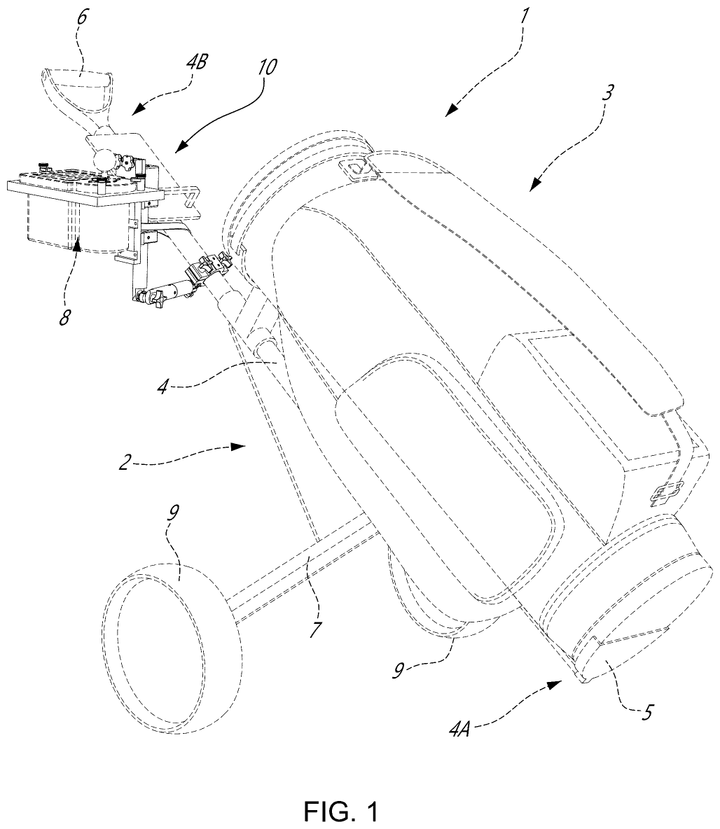

Referring to FIG. 1, a golf trolley is shown at 1 and includes a frame 2 for supporting a golf bag 3. The frame 2 includes a longitudinal post 4, also referred to as a frame member, extending from a bottom end 4A to a top end 4B. A bag support member 5 is mounted to the bottom end 4A and configured for retaining the golf bag 3 to the golf trolley 1. A handle 6 is mounted to the top end 4B of the longitudinal post 4 and is configured to be engaged by a hand of a user for moving the golf trolley 1 and the golf bag 3 mounted thereto. The frame 2 further includes transverse members 7 secured to the longitudinal post 4 and extending away therefrom. Wheels 9 are rollingly mounted at ends of the transverse members 7 for facilitating a movement of the golf trolley 1 on a grass surface. It will be appreciated that other kind of golf trolley 1 may be used without departing from the scope of the present disclosure.

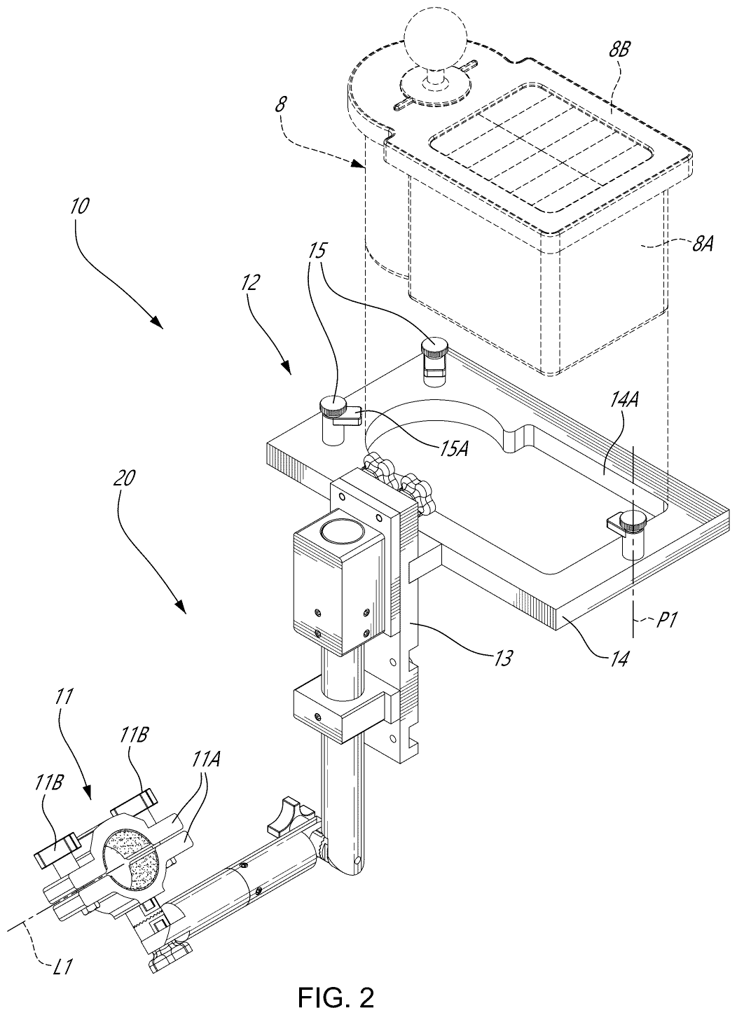

In some cases, it may be desired to carry a golf ball washing device 8 with oneself to be able to wash a golf ball as needed while playing. In the embodiment shown, a support 10 may be used for attaching the golf ball washing device 8 to the trolley 1. More specifically, the support 10 is configured to attach the golf ball washing device 8 to the longitudinal post 4 of the frame 2 of the trolley 1. It will be appreciated that the support 10 may be used to secure the golf ball washing device 8 to any structural member of the golf trolley 1. As observed from FIG. 2, the golf ball washing device 8 is of the type having a carriage that is movable vertically in a reciprocating movement when the golf ball washing device 8 is upright, for the golf ball in the washing device 8 to be brushed into a bath of liquid (e.g., soapy water) and brushes inside the golf ball washing device 8. Because liquid is contained in the golf ball washing device 8, it is important for the golf ball washing device 8 to remain generally upright and levelled relative to a ground to prevent spillage of the liquid.

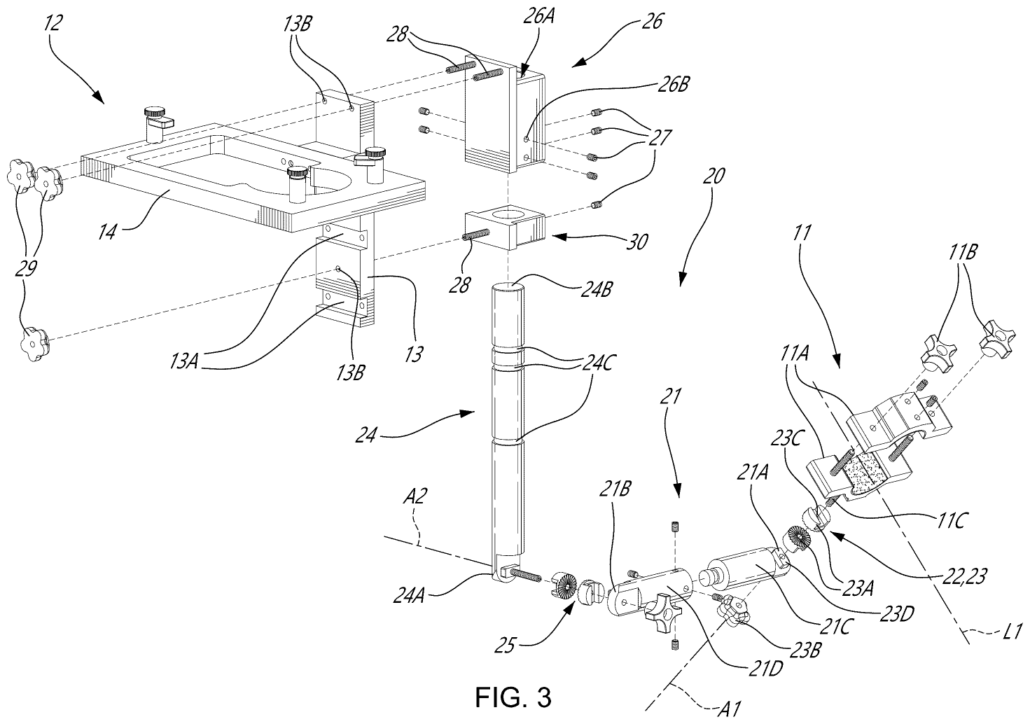

Referring now to FIGS. 2-3, the support 10 is shown and described in greater detail below. The support 10 includes a trolley-fastening member 11 configured for being removably secured to the longitudinal post 4 of the golf trolley 1. In the embodiment shown, the trolley-fastening member 11 extends around a longitudinal axis L1 being parallel to the longitudinal post 4. More specifically, the trolley-fastening member 11 includes a clamp having two arcuate members 11A conjointly extending around the longitudinal axis L1 being parallel to the longitudinal post 4 of the golf trolley 1. The two arcuate members 11A are secured to one another via fasteners 11B, such as thumb screws or any other suitable fastening means. For instance, a snap fit connection may be provided between the two arcuate members 11A. A damping material may be disposed between the arcuate members 11A and the longitudinal post 4 to prevent slippage. A shape of the two arcuate members 11A is selected to substantially match a shape of the longitudinal post 4 of the golf trolley 1. In this case, the longitudinal post 4 has a cylindrical shape and the two arcuate members 11A are configured to conjointly define a correspondingly shaped cylindrical shape to mate with the longitudinal post 4. Other shapes are contemplated such as, square, oval, etc. In an alternate embodiment, the trolley-fastening member 11 may be simply a plate fastened directly onto the longitudinal post 4. Any suitable ways of securing the support 10 to the frame 2 of the golf trolley 1 are contemplated.

The support 10 has a device holder 12 configured for supporting the golf washing device 8. The device holder 12 includes a support plate 13 and a support flange 14 secured to the support plate 13 and extending transversally therefrom. The support flange 14 extends peripherally around an aperture 14A sized to receive the golf ball washing device 8 therethrough. More specifically, the device 8 has a body 8A and a cover 8B. The aperture 14A of the support flange 14 is configured to receive the body 8A. The cover 8B of the device 8 is configured to abut against the support flange 14. In other words, the support flange 14 defines a shoulder for supporting the device 8. Locking pins 15, three in this embodiment, but more or less may be used, are pivotally mounted to the support flange 14 for rotation about a pin axis P1. The locking pins 15 define protrusions 15A extending transversally to the pin axis P1. The locking pins 15 are rotatable about the pin axis P1 between an unlocking position in which the protrusions 15A are offset from the cover 8B and a locking position in which the protrusions 15A overlap the cover 8B to lock the device 8 to the support flange 14. In other words, in the locking position of the locking pins 15, a periphery of the cover 8B of the golf ball washing device 8 is sandwiched between the protrusion 15A and the support flange 14. The locking pins 15 may be omitted in some configurations. It will be appreciated that any suitable means for supporting the device 8 are contemplated. For instance, the device holder 12 may be simply a band extending around the device 8 and tighten to hold the device 8 in place. In some other embodiments, the device 8 may be directly screwed to the support plate 13. A friction fit between the golf ball washing device 8 and the support flange 14 may be sufficient in some embodiments. In some cases, a weight of the golf ball washing device 8 may be sufficient to maintain it in the aperture 14A of the support flange 14.

As shown more distinctly in FIG. 3, the support plate 13 defines a plurality of slots 13A, three in the depicted embodiment, but more or less may be used, each being sized to receive a portion of the support flange 14. Thus, a position of the support flange 14 relative to the support plate 13 may be varied by positioning the support flange 14 is one of the slots 13A. Fasteners, such as screws, may then be used to secure the support flange 14 within a selected one of the slots 13A. In an alternate embodiment, the support flange 14 may be secured to one of the slots 13A via other means, such as dovetail, keyway, and so on.

The support 10 may be required to cater to a wide variety of trolleys. For instance, the shape, orientation relative to a ground, and so on of the frame 2 of the trolley 1 may vary from model to model. It may however be desired to position the device 8 substantially level relative to the ground. To this end, the support 10 includes a positioning mechanism 20 operatively connected to both of the device holder 12 and to the trolley-fastening member 11. As will be discussed in more detail below, the positioning mechanism 20 includes arms pivotably engaged to one another and operable to move the device holder 12 relative to the trolley-fastening member 11 about a plurality of degrees of freedom.

Referring more particularly to FIG. 3, the positioning mechanism 20 includes a first arm 21 extending from a first proximal end 21A pivotably mounted to the trolley-fastening member 11 to a first distal end 21B. A first anti-rotation feature 22 is provided between the first proximal end 21A and the trolley-fastening member 11 to selectively prevent rotation of the first arm 21 relative to the trolley-fastening member 11. In this embodiment, the first anti-rotation feature 22 is a first Hirth joint 23. The first Hirth joint 23 includes two annular members 23A having teeth mating with one another. The teeth cooperate to hinder rotation of the two annular members 23A relative to one another. A threaded shank 11C may protrude from one of the arcuate members 11A of the trolley-fastening member 11 and is received through registering apertures of the two annular members 23A and a thumb screw 23B is threadingly engaged to the threaded shank 11C. The first proximal end 21A of the first arm 21 and the two annular members 23A of the first Hirth joint 23 are located between the one of the arcuate members 11A and the thumb screw 23B such that tightening of the thumb screw biases the two annular members 23A against one another thereby forcing an engagement of the teeth of two annular members 23A to prevent rotation of the first arm 21 relative to the trolley-fastening member 11 about a first axis A1 being transverse to the first arm 21 and transverse to the longitudinal axis L1 of the longitudinal post 4 of the frame 2 of the golf trolley 1. To prevent rotation of the two annular members 23A relative to the trolley-fastening member 11 and the first proximal end 21A, the two annular members 23A define slots 23C being engaged by tabs 23D defined by both of the trolley-fastening member 11 and the first proximal end 21A. Understandably, the slots and tabs may alternatively be defined by the trolley-fastening member 11 and by the two annular members 23A, respectively. Any means to prevent rotation of the annular members relative to the first arm 21 and the trolley-fastening member 11 are contemplated. These means may include, for instance, pins, dog and slot, glue, etc. One of the annular members may be defined by the trolley-fastening member 11 while the other of the annular members may be defined by the first arm 21.

The positioning mechanism 20 further includes a second arm 24 extending from a second proximal end 24A pivotably mounted to the first distal end 21B of the first arm 21 to a second distal end 24B mounted to the device holder 12. The second proximal end 24A of the second arm 24 is rotatable relative to the first distal end 21B of the first arm 21 about a second axis A2 being transverse to both of the first arm 21 and the second arm 24 to vary an angle defined between the first arm 21 and the second arm 24. In the pictured embodiment, a second anti-rotation feature 25 is provided between the first distal end 21B and the second proximal end 24A to selectively prevent rotation between the first arm 21 and the second arm 24 about the second axis A2. As for the first anti-rotation feature 22, the second anti-rotation feature 25 may be a second Hirth joint as described herein above.

Still referring to FIG. 3, in the embodiment shown, the device holder 12 is mounted to the second arm 24 via an arm-engaging member 26. The arm-engaging member 26 acts as an interface between the device holder 12 and the second arm 24. The arm-engaging member 26 defines a bore 26A sized to receive the second arm 24 therethrough. The arm-engaging member is secured to the second arm 24 via fasteners 27, such as set screws. More specifically, the fasteners 27 extend through correspondingly-threaded apertures 26B that communicates with the bore 26A. The second arm 24 defines notches 24C extending circumferentially around a longitudinal axis of the second arm 24. The fasteners 27 have ends received within the notches 24C to block axial movements of the arm-engaging member 26 relative to the second arm 24. In a variant, the arm-engaging member 26 is part of a cylindrical joint with the second arm 24, enabling the height and/or orientation adjustment of the device holder 12.

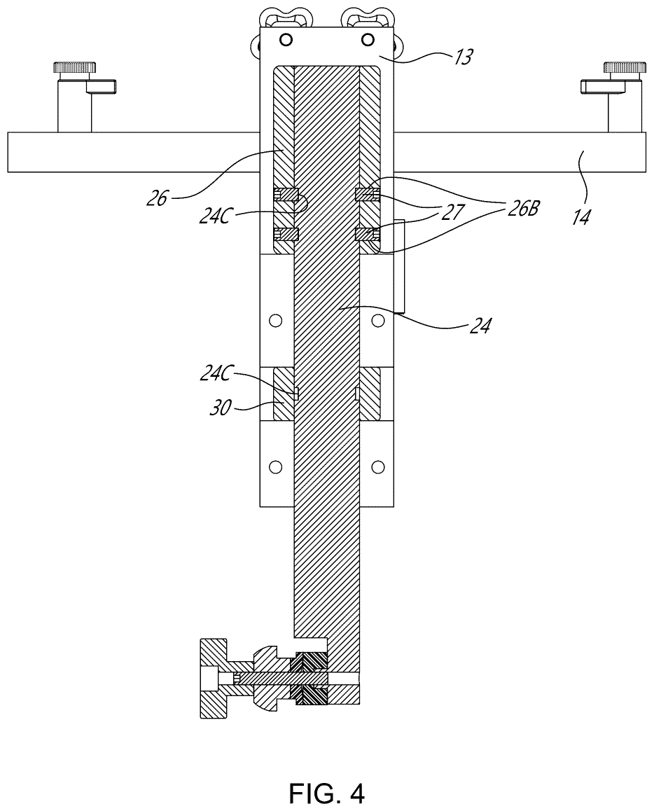

Referring to FIG. 4, the fasteners 27 may also provide a rotational adjustment of the device holder 12 relative to the second arm 24. Indeed, the fasteners 27 may be threaded into the apertures 26B until they are received into the notches 24C, but before they abut the second arm 24. At which point, the axial movement is prevented, but the arm-engaging member 26 may still rotate relative to the second arm 24 until a desired position is achieved. At which point, the fasteners 27 may be tighten to abut against the second arm 24 thereby limiting rotation of the arm-engaging member 26 of the second arm 24. Only one fasteners 27 may be used in some embodiments.

Referring back to FIG. 3, in the embodiment shown, the support plate 13 is removably mounted to the arm-engaging member 26 via threaded shanks 28 received through apertures 13B of the support plate 13. Thumb nuts 29 are used to secure the support plate 13 to the arm-engaging member 26. The thumb nuts 29 are threadingly engaged to the threaded shanks 28 and tighten to securely hold the support plate 13 to the arm-engaging member 26.

In the depicted embodiment, a second-arm engaging member 30 is provided. The second-arm engaging member 30 is similar to the arm-engaging member 26 in that it defines a bore and is used to secure the second arm 24 to the support plate 13. Features of the arm-engaging member 26 described above apply also to the second-arm engaging member 30 and are not repeated. It will be appreciated that the second-arm engaging member 30 may be omitted in some configurations.

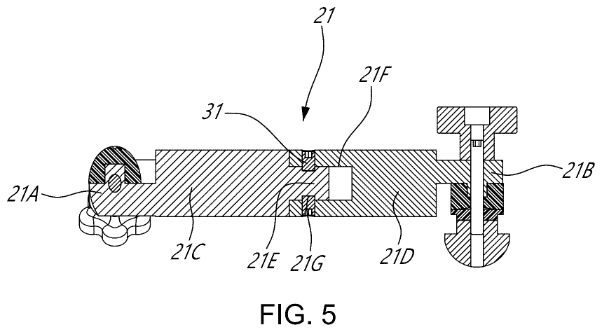

Referring now to FIG. 5, in the depicted embodiment, the first arm 21 includes a first arm section 21C and a second arm section 21D mounted coaxially to the first arm section 21C. The first arm section 21C is rotatable relative to the second arm section 21D about a longitudinal axis of the first arm 21. In the embodiment shown, the first arm section 21C defines a male member 21E receivable within a female member 21F defined by the second arm section 21D. The male and female members may be interchanged in some embodiments. As depicted, the male member 21E may be locked to the female member 21F with one or more fasteners 31, such as set screws. The fasteners 31 extend through apertures defined by the second arm section 21D and are received into a notch 21G defined by the male member 21E of the first arm section 21C. Therefore, the first arm section 21C is rotatable relative to the second arm section 21D to provide a further degree of freedom to adjust the relative position of the golf ball washing device 8 relative to the trolley 1. Once the desired position is achieved, the fasteners 31 may be tighten to prevent rotation of the two arm sections one relative to the other.

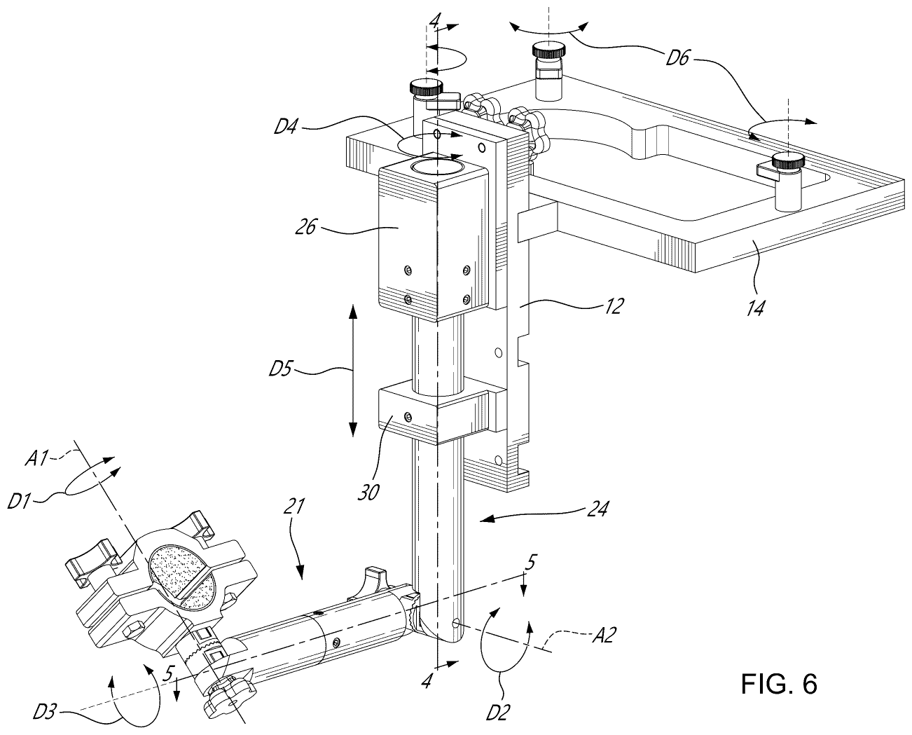

Referring now to FIG. 6, the different possibilities to adjust the position of the device holder 12 relative the trolley-fastening member 11 are illustrated with arrows. As illustrated, the first arm 21 may be pivoted relative to the trolley-fastening member 11 about the first axis A1 along direction D1. The first axis A1 is transverse to the frame member of the trolley 1. This may be used to adjust a distance between the golf ball washing device 8 and the longitudinal post 4. The second arm 24 may be pivoted relative to the first arm 21 around the second axis A2 about direction D2. The second axis A2 is perpendicular to both of the first arm 21 and the second arm 24. This movement may be used to level the support flange 14 relative to the ground. The second arm 24 may be pivoted relative to the first arm 21 about a longitudinal axis of the first arm 21 about direction D3 by pivoting the two sections of the first arm 21 one relative to the other. This movement may also be used to level the support flange 14 relative to the ground. The device holder 12 may be pivoted about the second arm 24 along direction D4. This may be used to ensure that the golf ball washing device 8 does not hinder handling of the trolley 1. Then, the device holder 12 may be moved axially relative along the second arm 24 along direction D5 by selecting in which one of the slots 13A of the support plate 13 the support flange 14 is engaged. This may be used to adjust a height of the golf ball washing device 8 relative to the ground per a user's preference. The locking pins 15 may be rotated about direction D6 to selectively lock or unlock the golf ball washing device 8 to the support flange 14. This may permit removal of the device for maintenance or replacement, for instance.

Understandably, these different degrees of freedom allows the support 10 to be affixed to a plurality of shape of frames of different kind of trolleys. It may permit the leveling of the support flange 14, and of the golf ball washing device 8 supported thereto relative to the ground. It may also provide a degree of adjustability to suite a user's preference with regards to height and position relative to the ground and relative to the trolley 1.

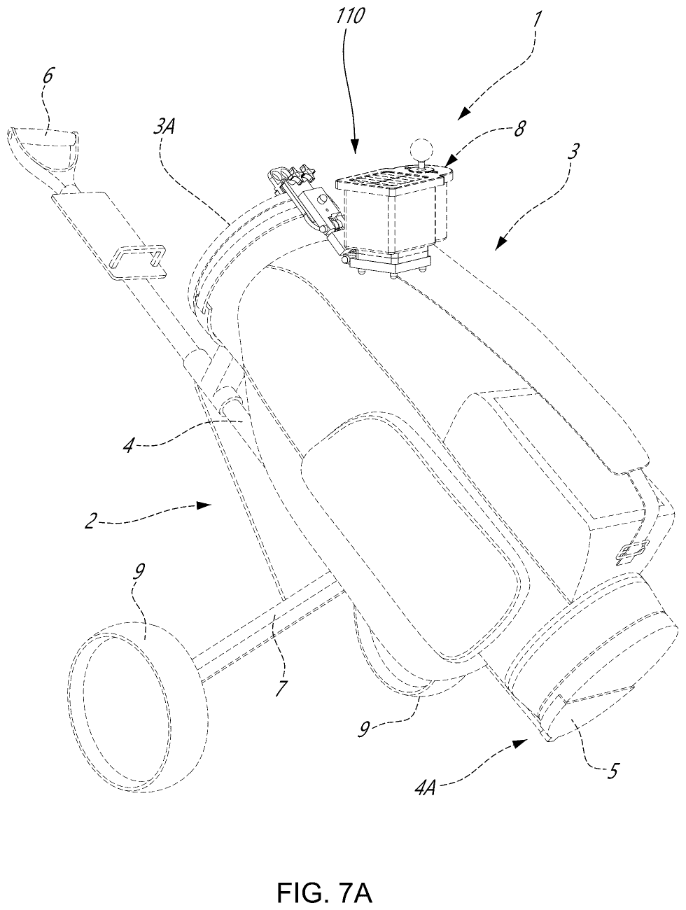

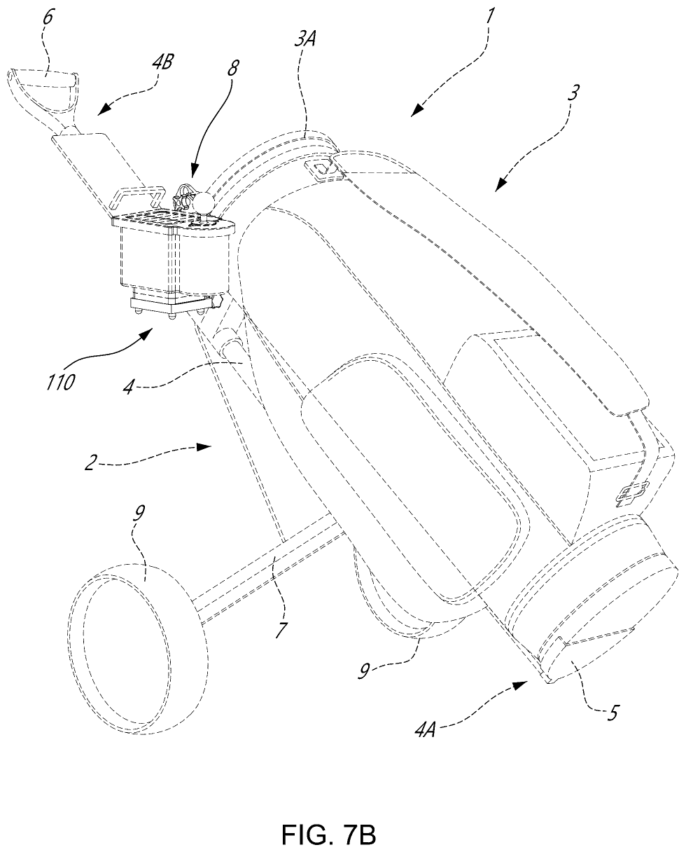

Referring to FIGS. 7A and 7B, another embodiment of a support for the golf ball washing device is shown at 110. For the sake of conciseness, only features differing from the support 10 described above are described below. As illustrated, the support 110 may be installed at a plurality of locations on the golf bag 3. In FIG. 7A, the support 110 is shown installed to a front portion of a rim 3A that surrounds an opening via which golf clubs are inserted in the golf bag 3. In FIG. 7B, the support 110 is secured to a lateral portion of the rim 3A. Other locations are contemplated.

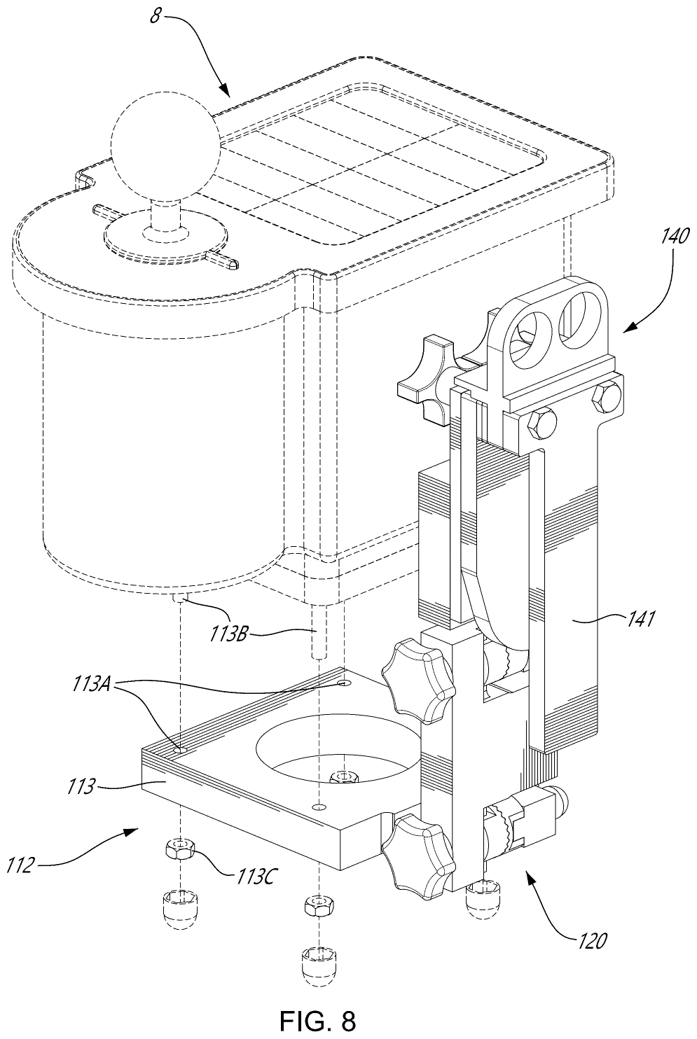

Referring now to FIG. 8, the support 110 is shown in greater detail. The support 110 has a device holder 112 configured for supporting the golf ball washing device 8. The device holder 112 includes a support member 113. The support member 113 may be a plate or any suitable member securable to the golf ball washing device 8. In this embodiment, the support member 113 is secured to an underside of the golf ball washing device 8. For instance, the support member 113 may define apertures 113A sized to receive bolts 113B secured to the golf ball washing device 8. Nuts 113C may be threadingly engaged to the bolts 113B to secure the golf ball washing device 8 to the support member 113. It will be appreciated that the device holder 112 may be any means configured for being secured to the golf ball washing device 8 for support thereof. In some embodiments, the support 110 may include the device holder 12 described above with reference to FIG. 3. The support member 113 may include a bore for receiving a portion of the device 8. This bore may be omitted in some configurations.

The support further includes a positioning mechanism 120 and a fastening member 140. The positioning mechanism 120 is configured to permit a user to change an orientation of the golf ball washing device 8 relative to the golf bag 3. The fastening member 140 is configured for mounting the support 110 to the golf bag 3. These elements are described below.

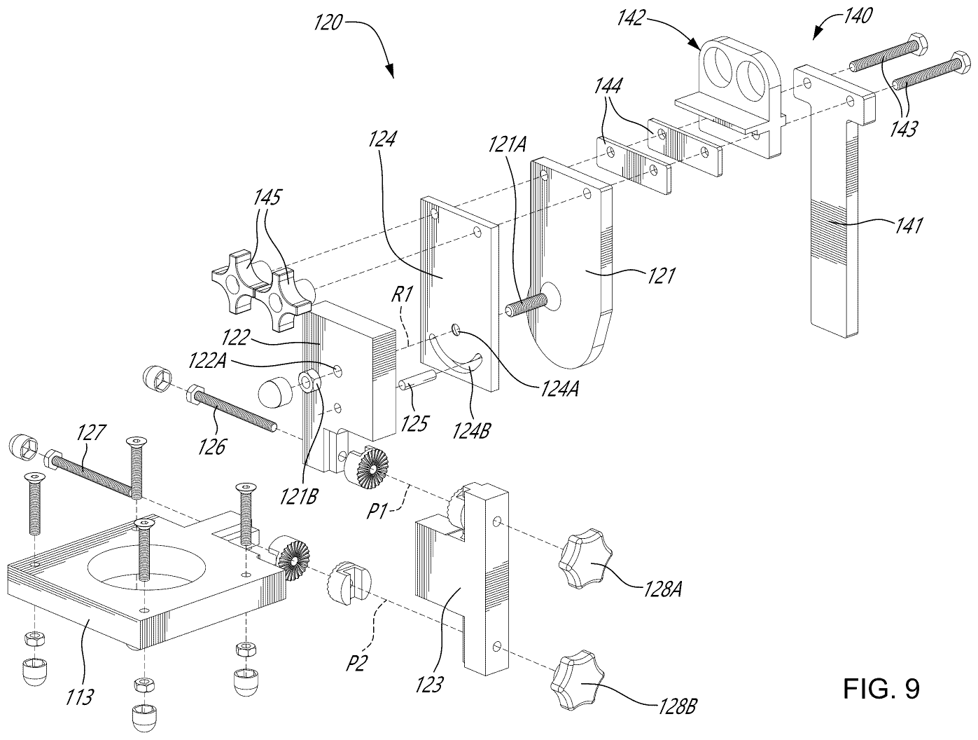

Referring to FIG. 9, the positioning mechanism 120 is described in greater detail. The positioning mechanism includes arms, three arms in this embodiment, but more or less may be used, that are pivotally engaged to one another and that are provided in the form of a first plate 121, a second plate 122 pivotally connected to the first plate 121 for rotation about a roll axis R1, and a third plate 123 pivotally connected to the second plate 122 for rotation about a first pitch axis P1 being perpendicular to the roll axis R1. The support member 113 is pivotally engaged to the third plate 123 for rotation about a second pitch axis P2 being parallel to the first pitch axis P1. The first pitch axis P1 and the second pitch axis P2 are perpendicular to the roll axis R1. Expressions “arms” and “plates” may be used interchangeably when referring to the positioning mechanism 20, 120. Any members interconnectable to one another may be used for the positioning mechanism 20, 120 without departing from the scope of the present disclosure.

A threaded shank 121A protrudes transversally from the first plate 121 and extends through an aperture 122A defined through the second plate 122. The second plate 122 is thus pivotable relative to the first plate 121 about the threaded shank 121A, which is coincident with the roll axis R1. A nut 121B may be tighten to bias the second plate 122 against the first plate 121 to lock the second plate 122 to the first plate 121 in a desired relative orientation. Other means for locking these two plates together are contemplated. For instance, a locking pin may be used or any other suitable means.

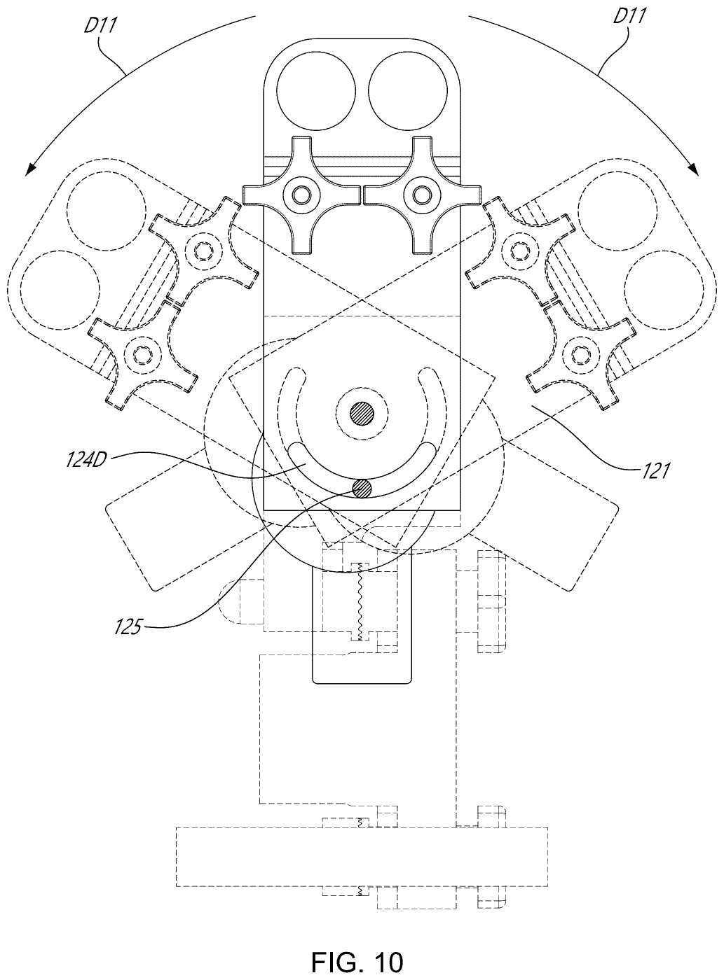

To constraint an amplitude of the movement of the second plate 122 relative to the first plate 121, an intermediary plate 124 is disposed between the first plate 121 and the second plate 122. The intermediary plate 124 is secured to the first plate 121 via any suitable fastening means, such as fasteners. The intermediary plate 124 defines an aperture 124A that slidably receives the threaded shank 121A and defines an arcuate slot 124B. A pin 125 is fixedly connected to the second plate 122 and extends transversally therefrom. The pin 125 is slidably receives into the arcuate slot 124B. The rotation of the second plate 122 relative to the first plate 121 is therefore constrained to an amplitude defined by the arcuate slot 124B as the pin 125 will abut ends of the slot if further rotation is attempted. It will be appreciated that the arcuate slot may instead be defined by the first plate 121 and the intermediary plate 124 may be omitted in some embodiments. The pin 125 and the arcuate slot 124B may also be omitted in some embodiments. As shown in FIG. 10, the first plate 121 is pivotable relative to the second plate 122 such as to allow a movement along direction D11.

Still referring to FIG. 9, in the embodiment shown, the second plate 122 and the third plate 123 are pivotable one relative to another about a first threaded fastener 126 received through registering apertures defined by the second plate 122 and third plate 123. Anti-rotation feature, such as a Hirth joint, may be used to lock the second plate 122 relative to the third plate 123. These anti-rotation features are described above. Any other suitable anti-rotation features may be used. Similarly, a second threaded fastener 127 is received through registering apertures defined by the support member 113 and the third plate 123. Another anti-rotation feature, such as a Hirth joint, may be used to lock the third plate 123 relative to the support member 113. Hence, first and second thumb nuts 128A, 128B may be loosened or tighten to selectively permit rotation of the second plate 122 relative to the third plate 123 about the first pitch axis P1, and to permit rotation of the third plate 123 relative to the support member 113 about the second pitch axis P2 to adjust a position of the golf ball washing device 8.

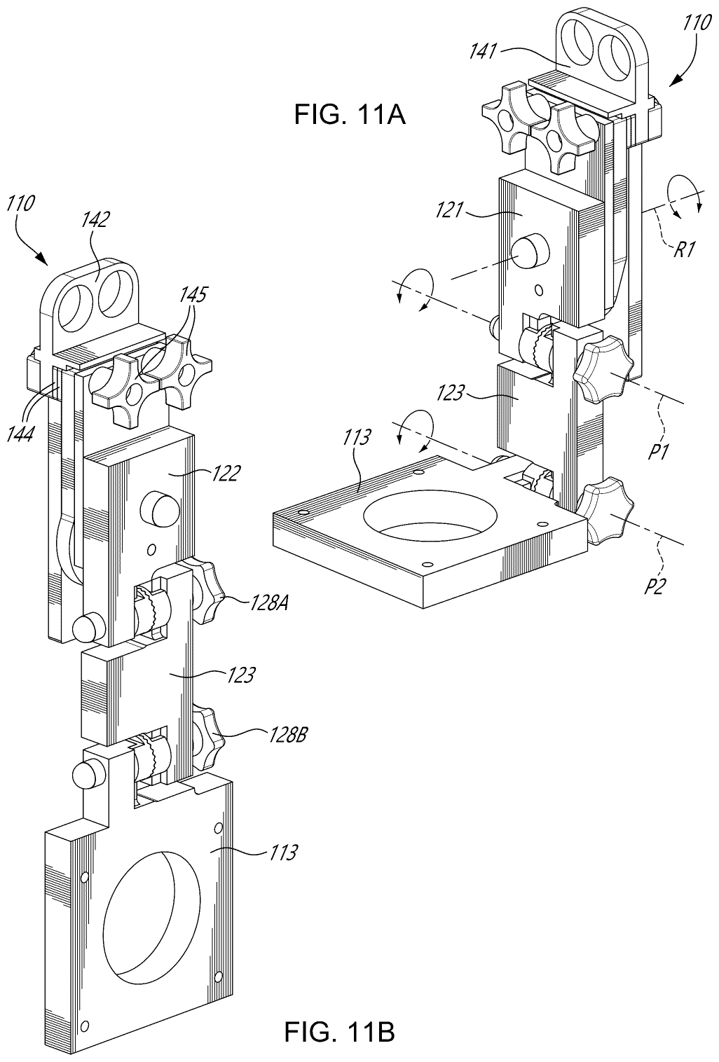

Referring to FIGS. 11A-11B, as one may appreciate, the positioning mechanism 120 permits the adjustment of the support 110 in a plurality of degree of freedom: rotation of the second and third plate 122, 123 about the first pitch axis P1, rotation of the third plate 123 and the support member 113 about the second pitch axis P2, and rotation of the first plate 121 relative to the second plate 122 about the roll axis R1.

Referring back to FIG. 9, the fastening member 140 will now be described. The fastening member 140 is used to secure the support 110 to the golf bag 3. To this end, the fastening member 140 includes a vertical tab 141. The vertical tab 141 is sized to be inserted into the opening of the golf bag 3 and to retain the support 110 on the rim 3A of the golf bag 3. In the embodiment shown, a handle 142 is secured to the vertical tab 141 to help a user installing or removing the support 110 from the golf bag 3. The handle 142 may define apertures sized to receive one or more finger(s) of a hand of the user. The handle 142 may be omitted in some configurations. The vertical tab 141 is secured to the first plate 121 via suitable fasteners 143. In some embodiments, the first plate 121 and the vertical tab 141 may be parts of a single monolithic body. Thumb screws 145, two in this embodiment, but more or less may be used, are used to removably secure the first plate 121 to the vertical tab 141. The vertical tab 141 and the plates may have a width sufficient to limit the support from pivoting around the rim 3A of the golf bag 3.

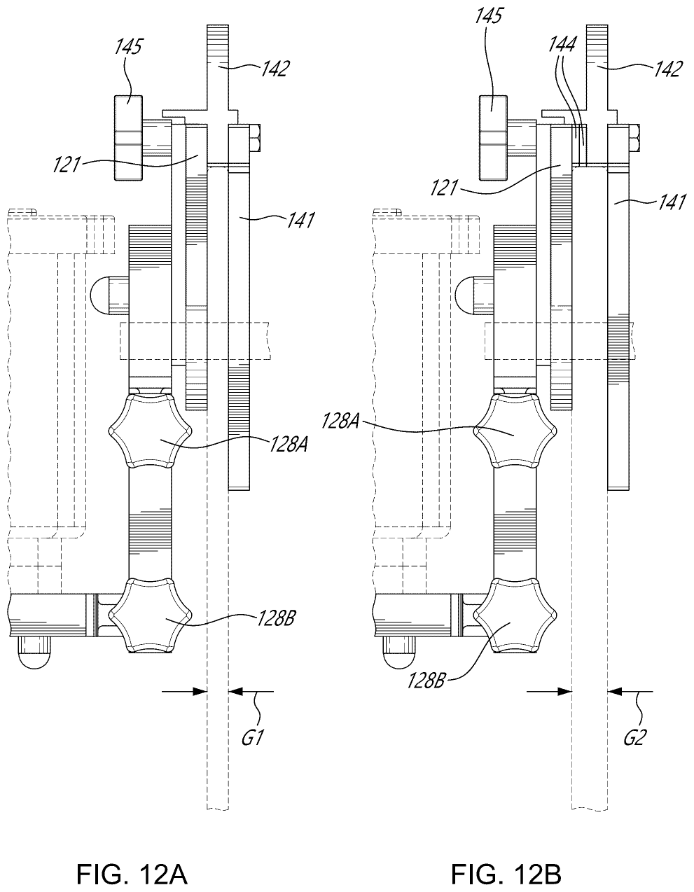

Referring to FIGS. 9 and 12A-12B, in this embodiment, shims 144—two illustrated but more or less may be used—may be disposed between the first plate 121 and the vertical tab 141. A gap defined between the first plate 121 and the vertical tab 141 may be increased from a baseline gap G1 to an enlarged gap G2 by the use of the shims 144. This may be required to ensure that the gap between the first plate 121 and the vertical tab 141 is adapted to a thickness of the rim 3A of the bag 3. The user may select whether or not to install the shim(s) 144 based on the thickness of the rim 3A of his or her bag. The thumb screws 145 may permit the easy installation or removal of the shim(s) 144, if needed.

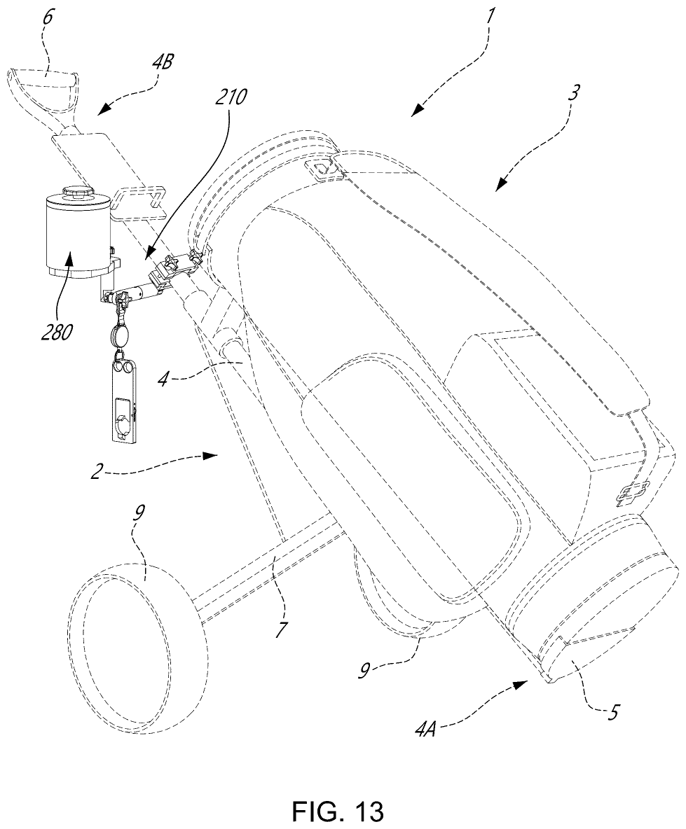

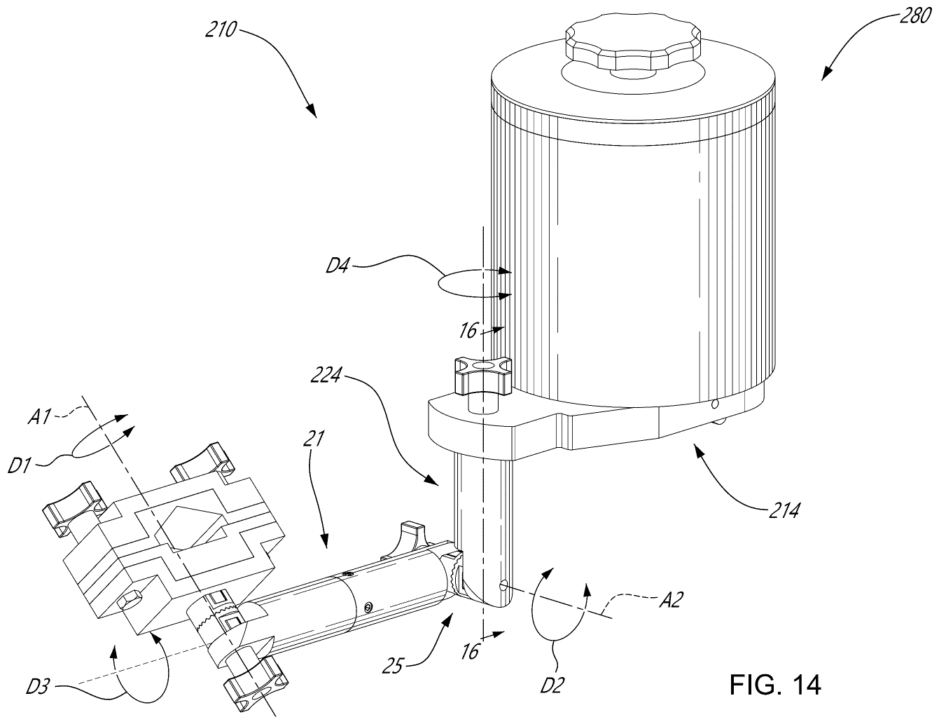

Referring now to FIGS. 13-14, another embodiment of a support is shown at 210. For the sake of conciseness, only features differing from the support 10 of FIG. 1 are described below.

In the present embodiment, the support 210 is configured to hold a golf ball washing device 280 of another embodiment, which will be described further below. The support has a second arm 224, which is pivotably engaged to the first arm 21 and includes the second anti-rotation feature 25 to selectively lock the first arm 21 relative to the second arm 224 in a desired relative orientation. The support 210 includes a support plate 214 configured for supporting the golf ball washing device 280. The support plate 214 is removably secured to the second arm 224, herein to an end of the second arm 224, via a fastener, but other fastening means such as keyway, snap fit, and so on are contemplated.

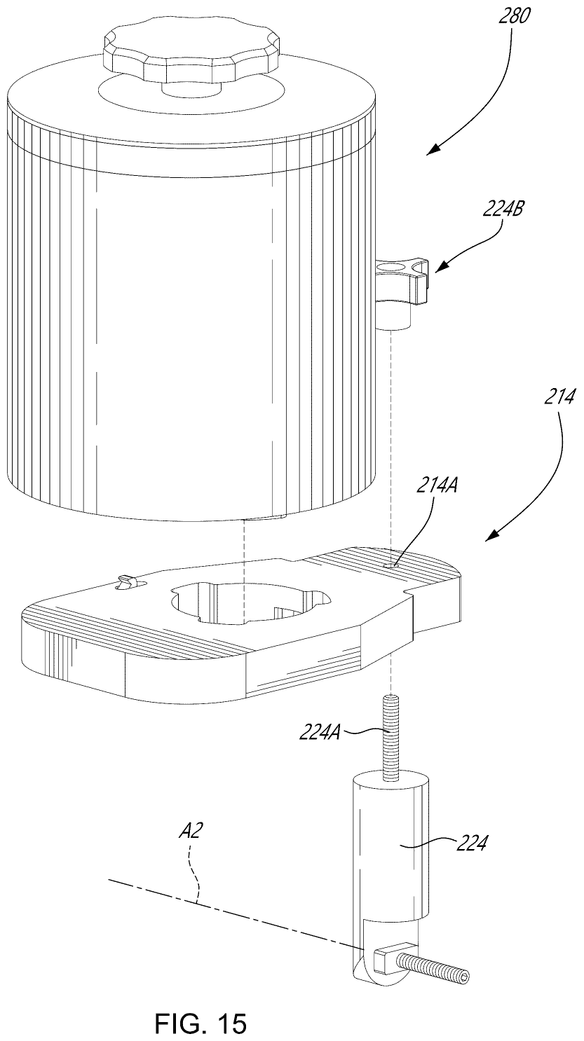

As shown in FIG. 15, a threaded shank 224A protrudes substantially parallel to the second arm 224 and is slidably received through an aperture 214A of the support plate for a nut 224B to threadingly engage the threaded shank 224A. In the context of the present disclosure, the expression “substantially” as in “substantially parallel” implies slight deviations from parallel caused by manufacturing tolerances for instance.

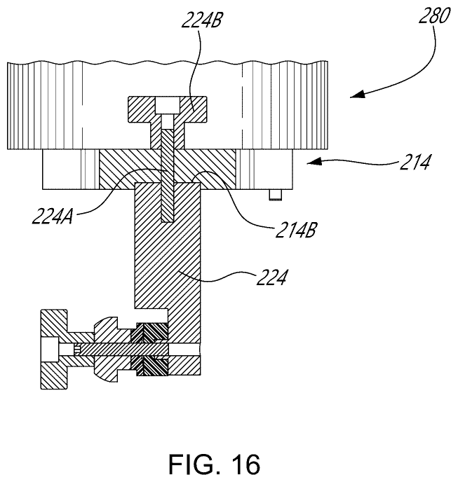

As depicted in FIG. 16, the threaded shank 224A is threadingly engaged within a correspondingly threaded bore defined by the second arm 224. Also, the support plate 214 may define a recess 214B for receiving an end of the second arm 224. This is optional, but may facilitate an assembly of the second arm 224 to the support 214 while improving a stability of the support 210.

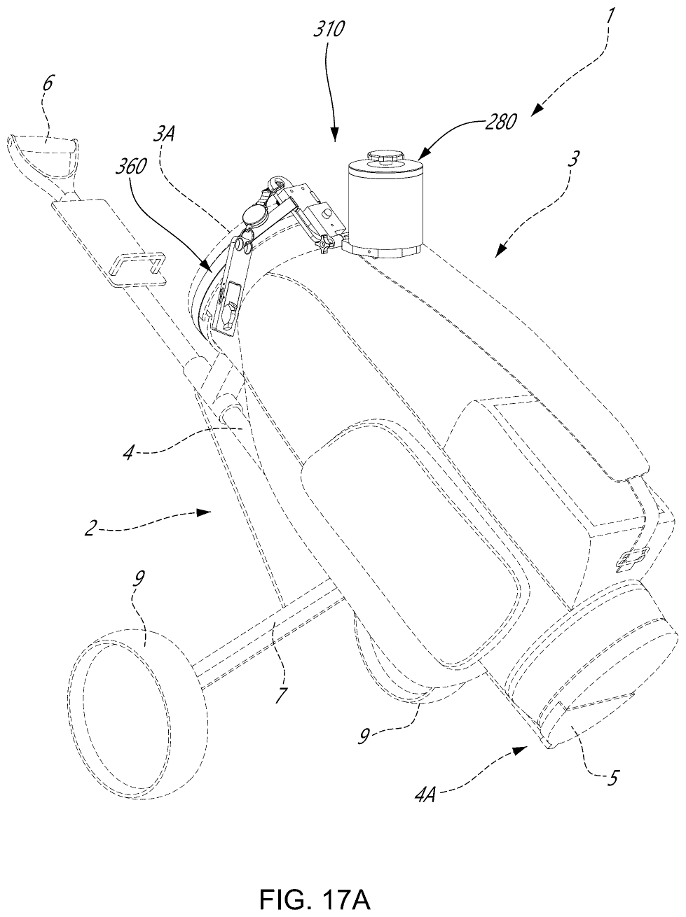

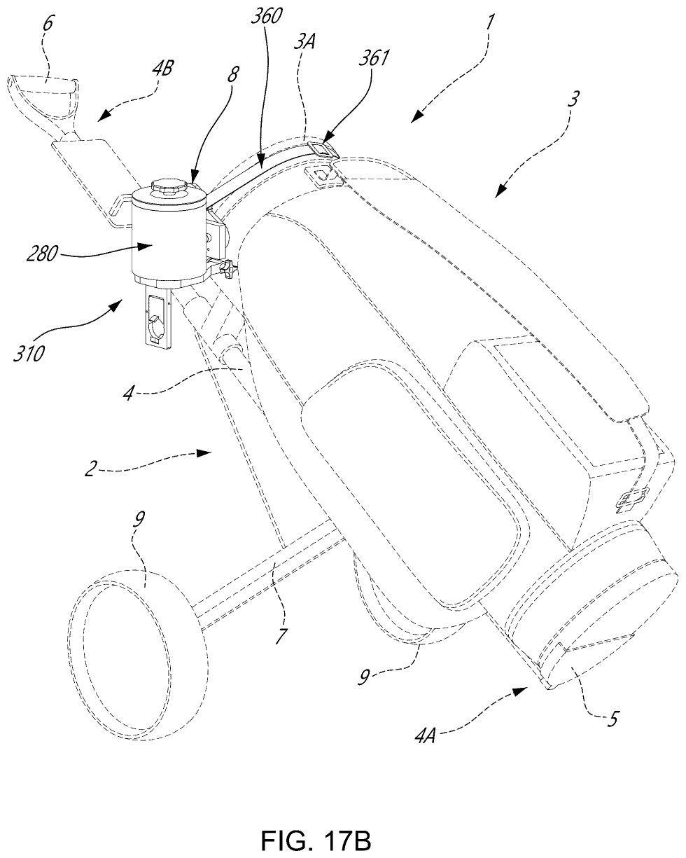

Referring now to FIGS. 17A and 17B, another embodiment of a support is shown at 310. For the sake of conciseness, only features differing from the support 110 of FIG. 7A are described below.

The support 310 is configured to be attached directly to the golf bag 3 at or proximate the rim 3A. In the present embodiment, the securing of the support 310 to the golf bag 3 is done via a strap 360. The strap 360 may be tighten around the golf bag 3. This allows a user to select a desired position of the support 310, and of the golf ball washing device 280 secured thereto, relative to the golf bag 3. Two possible positions are shown respectively in FIGS. 17A and 17B, but other positions are possible. The strap 360 may include a tightening mechanism 361, such as of a ratchet type, to secure the strap 360 to the golf bag 3. Alternatively, the tightening mechanism 361 may be omitted and the strap 360 may be elastic and have a diameter smaller than the golf bag 3 to ensure a tight fit therebetween.

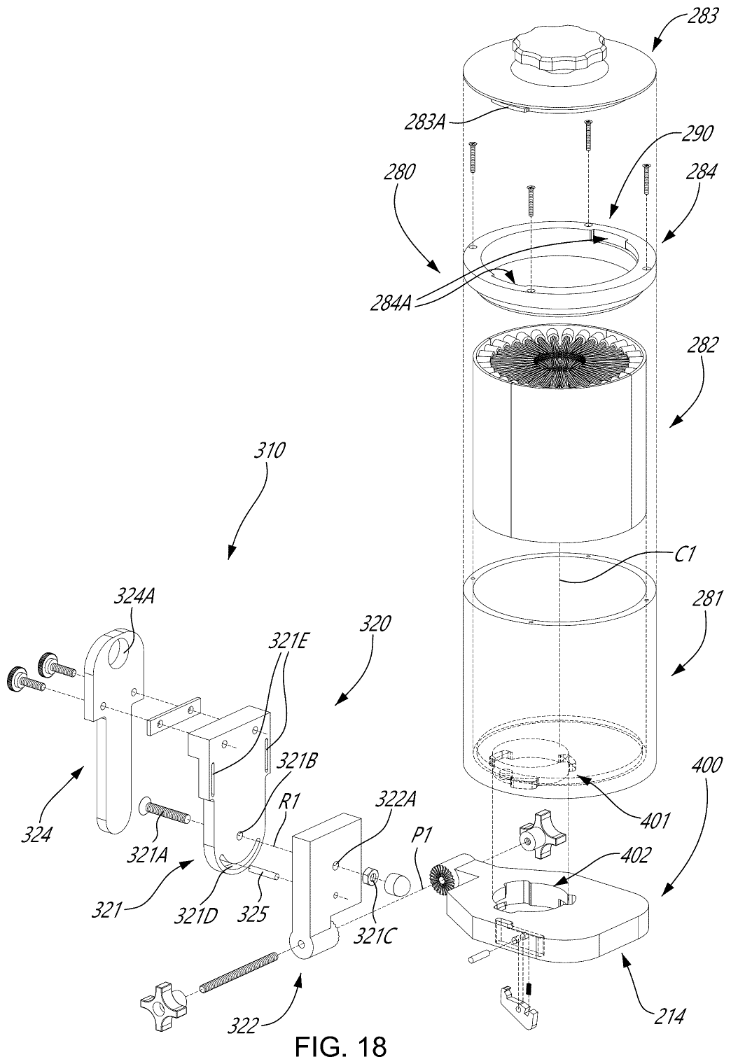

Referring now to FIG. 18, the support 310 includes a positioning mechanism 320 similar to the positioning mechanism 120 of FIG. 9. The positioning mechanism 120 is configured to permit a user to change an orientation of the golf ball washing device 8 relative to the golf bag 3. The positioning mechanism 320 includes a first plate 321, a second plate 322 pivotally connected to the first plate 321 for rotation about the roll axis R1. The second plate 322 is pivotally connected to the support plate 214 for rotation about the first pitch axis P1, which is perpendicular to the roll axis R1. The pitch and roll axes need not intersect one another.

A threaded shank 321A extends through registering apertures 321B, 322A defined through the first plate 321 and the second plate 322. The second plate 322 is thus pivotable relative to the first plate 321 about the threaded shank 321A, which is coincident with the roll axis R1. A nut 321C may be tighten to bias the second plate 322 against the first plate 321 to lock the second plate 322 to the first plate 321 in a desired relative orientation. Other means for locking these two plates together are contemplated. For instance, a locking pin may be used or any other suitable means.

To constraint an amplitude of the movement of the second plate 322 relative to the first plate 321, an arcuate slot 321D is defined through the first plate 321 below the aperture 321B. A pin 325 is fixedly connected to the second plate 322 and extends transversally therefrom. The pin 325 is slidably receives into the arcuate slot 321D. The rotation of the second plate 322 relative to the first plate 321 is therefore constrained to an amplitude defined by the arcuate slot 321D as the pin 325 will abut ends of the slot if further rotation is attempted. It will be appreciated that the arcuate slot 321D may instead be defined by the first plate 321. The pin 325 and the arcuate slot 322D may also be omitted in some embodiments. The first plate 321 further defines two slots 321E sized to receive the strap 360 therethrough.

In the embodiment shown, an anti-rotation feature, such as a Hirth joint, may be used to lock the second plate 322 relative to the support plate 214. These anti-rotation features are described above. Any other suitable anti-rotation features may be used.

A back plate 324 is secured to the first plate 321 via fasteners, such as thumb screws, although other fastening means may be used. The back plate 324 defines an aperture 324A therethrough used to attach a ball holding device of the golf ball washing device 280 as will be described further below. A shim may be disposed between the back plate 324 and the first plate 321. In some embodiments, the back plate 324 may be omitted and the ball holding device may be attached to the first plate 321 of any other parts of the support 310, or even to the golf bag 3.

Referring now to FIGS. 18-20, the golf ball washing device 280 is described in greater detail. The golf ball washing device 280 includes a container 281, a bristle cartridge 282, and a cover 283. As will be described below, the container 281 is detachably securable to the support 214 via a locking mechanism 400. The container 281 encloses a volume sized for receiving the bristle cartridge 282. The locking mechanism 400 may be mounted to a bottom wall of the container 281 to meet with the support plate 214 as explained below. A locking flange 284 is detachably securable to the container 281 to lock the bristle cartridge 282 inside the container 281. Fasteners may be used and may extend through registering apertures defined through the locking flange 284 and a peripheral wall of the container 281. Other means are contemplated, such as dog and slot, threading engagement, and so on.

The locking flange 284 and the cover 283 may be locked one relative to another via a cover locking mechanism 290. The cover locking mechanism 290 includes slots 284A defined by the locking flange 284 and tabs 283A defined by the cover 283. As shown, the slots 284A, two in the embodiment shown, but more or less may be used, have first open portions and second closed portions communicating with the first open portions. The tabs 283A are sized to be received into the first open portions in an axial direction relative to a central axis C1 of the container 281. Once the tabs 283A are in the first open portions of the slots 284A, the cover 283 may be rotated about the central axis C1, in a clockwise direction in this embodiment, to slidably receive the tabs 283A in to the second closed portions of the slots 284A. The cover 283 is then axially locked to the locking flange 284 via the tabs 283A received in the second closed portions of the slots 284A. An axial abutment is then defined between the tabs 283A and the locking flange 284. This locking mechanism may be referred to as a bayonet style or dog and slot style mechanism, but other locking mechanisms may be used. For instance, the cover 283 maybe threadingly engaged to the container 281 and/or the locking flange 284. The locking flange 284 may be omitted in some embodiments.

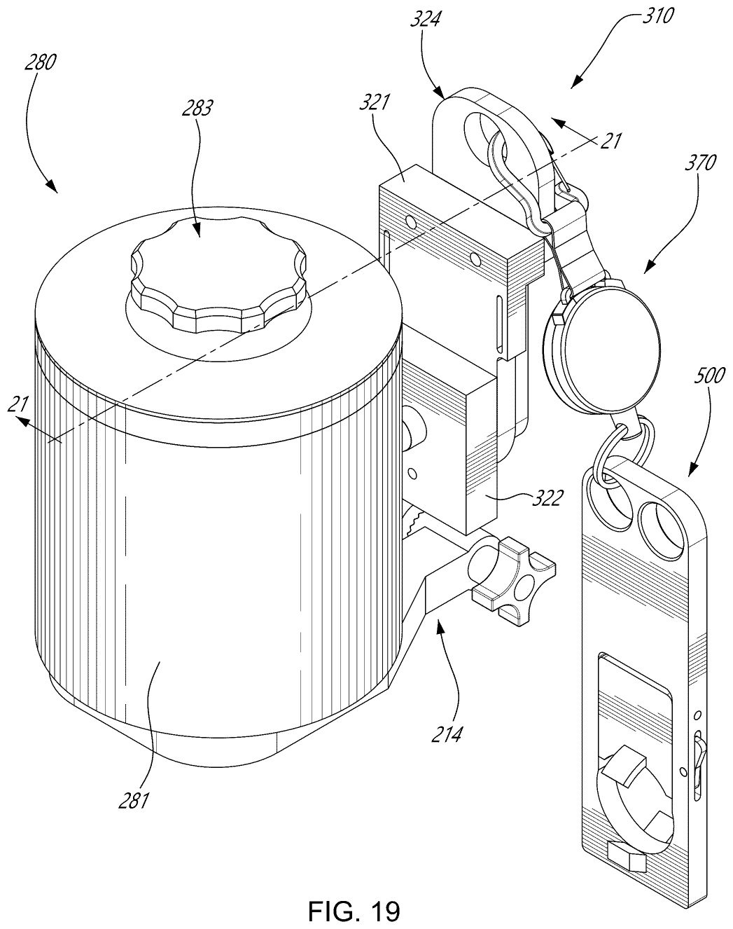

As shown in FIG. 19, the golf ball washing device 280 further includes a ball holding device 500, which will be described below. The device 500 is held to the support 310 using a retractable rope 370, but other means may be used. The device 500 may be clipped on the support 310 and/or the container 281. Hook and loop fasteners may be used. Any suitable means of holding the device 500 maybe used. In some cases, the device 500 may be stored into pocket of the golf bag 3 or secured to the golf trolley 1.

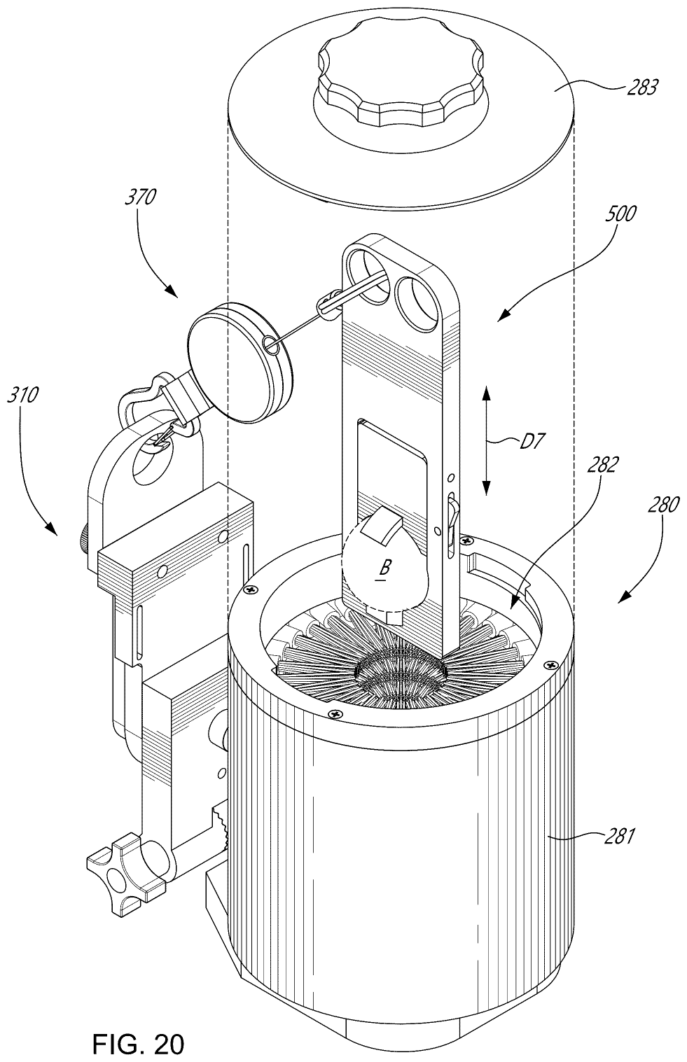

As shown in FIG. 20, to wash a ball B, a user first secures the ball B to the device 500, open the golf ball washing device 280 by pulling out the cover 283 to give access to the bristle cartridge 282, and perform reciprocating motions of the device 500 and ball B secured thereto along directions D7, being substantially parallel to the central axis C1, until the ball B is satisfactorily cleaned.

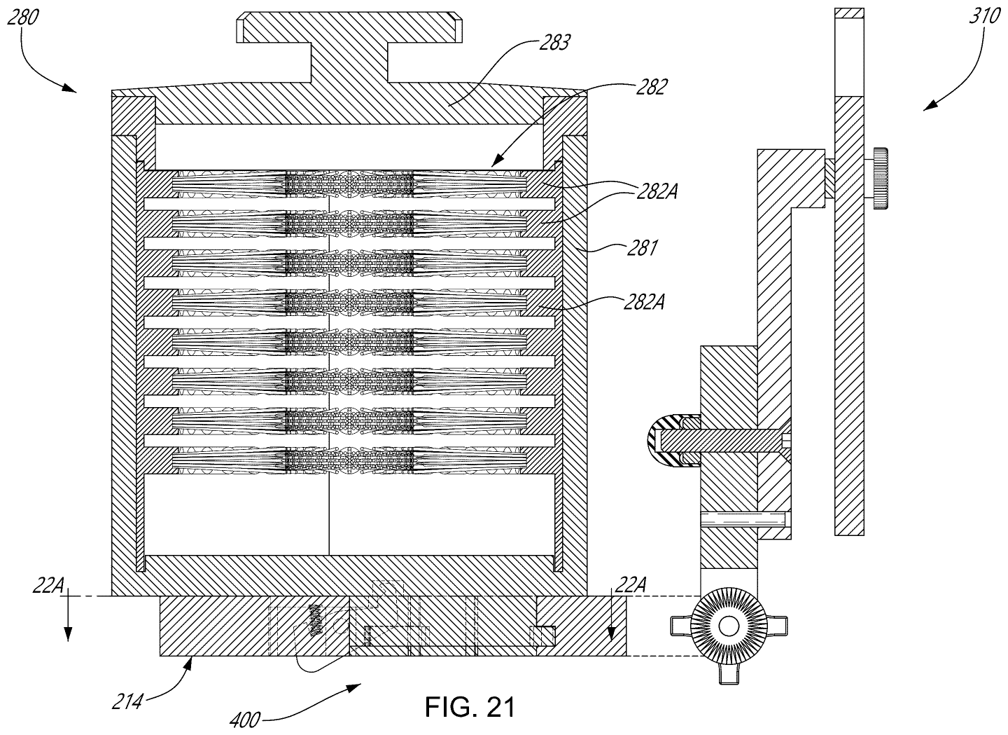

Referring to FIG. 21, the bristle cartridge 282 includes a plurality of bristle sections 282A axially distributed along the central axis C1 and circumferentially distributed around the central axis C1. Each of those sections 282A include a plurality of bristles. The bristles extend from bases at the peripheral wall of the container 281 to tips. In this embodiment, the tips are radially offset from the central axis C1 a sufficient distance to allow penetration of the golf ball B. Hence, the tips of the bristles encloses a substantially cylindrical volume having a diameter that may be less than that of the golf ball B such that the reciprocating motion causes the bristles to rub against the ball B to remove debris and other pollutants. The bristle cartridge 282 may be removable from the container 281 to allow replacement of the bristle cartridge 282 once the bristles become worn out after prolonged usage.

Referring now to FIGS. 18, 21, and 22A to 22D, the golf ball washing device 280 is detachably engageable to the support plate 214 via the locking mechanism 400. The locking mechanism 400 allows a user to remove the golf ball washing device 280 from the support 310 without having to detach the support 310 from the golf bag 3 or trolley 1. This may facilitate maintenance (e.g., cleaning) of the golf ball washing device 280 between games.

The locking mechanism 400 includes a male member 401 defined by one of the golf ball washing device 280 and the support plate 214 and a female member 402 defined by the other of the golf ball washing device 280 and the support plate 214. Herein, the male member 401 is defined by the container 281 of the golf ball washing device 280 and protrudes from a bottom wall thereof. The female member 402 is defined by the support plate 214.

The male member 401 includes a plurality of tabs 401A while the female member 402 includes a plurality of slots 402A. The slots 402A have open and closed sections that are circumferentially offset from one another. To engage the male member 401 to the female member 402, the tabs 401A are circumferentially aligned with the open sections of the slots 402A and the golf ball washing device 280 is move downwardly along the central axis C1 until the tabs 401A are received within the open sections of the slots 402A. At which point, the golf ball washing device 280 may be rotated about an axis that is parallel to the central axis C1 to slidably move the tabs 401A of the male member 401 into the closed sections of the slots 402A to thereby prevent axial movements of the golf ball washing device 280 relative to the support plate 214. An axial abutment is then defined between the tabs 401A and the support plate 214. This may be referred as a dog and slot or bayonet type locking mechanism. It will be appreciated that other locking mechanisms may be used without departing from the scope of the present disclosure. For instance, the golf ball washing device 280 maybe threadingly engaged to the support plate 214 using correspondingly threaded male and female members. Any other suitable locking mechanism may be used.

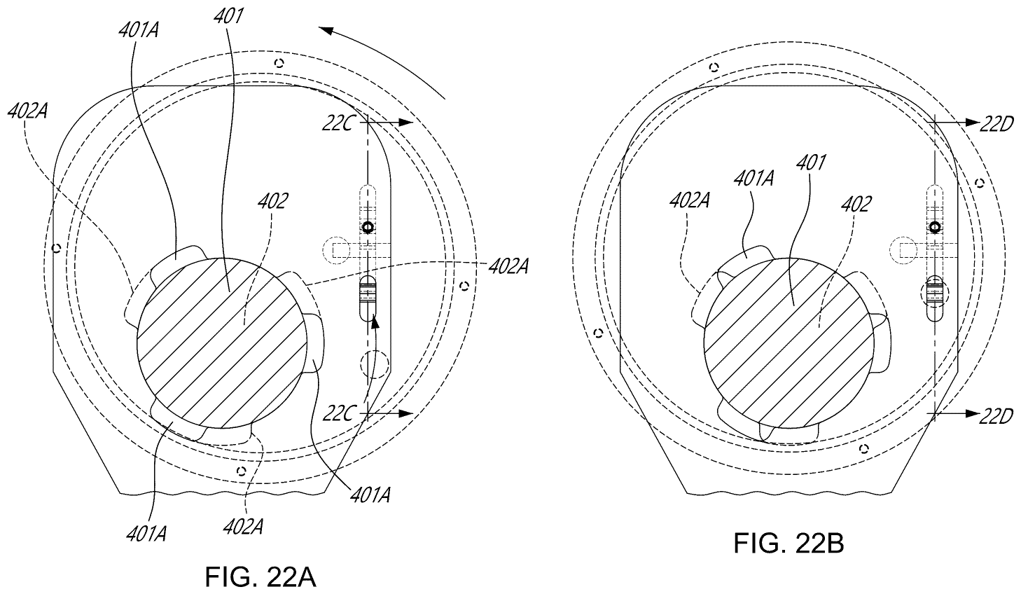

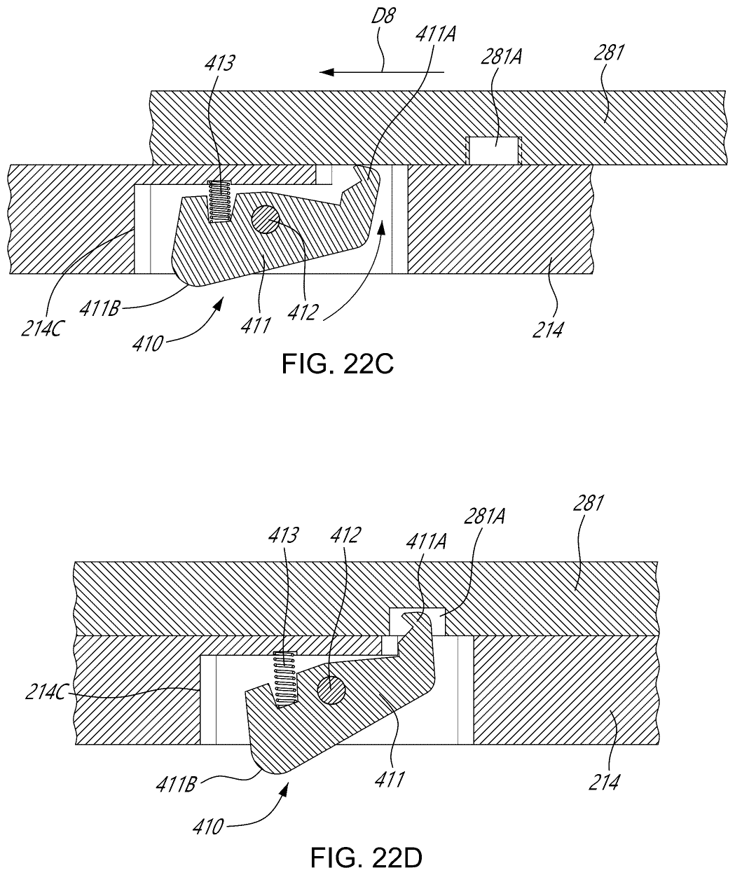

Referring to FIGS. 22C, 22D, the locking mechanism 400 further includes a locking device 410 used to maintain the tabs 401A of the male member 401 engaged into the closed sections of the slots 402A. FIGS. 22C and 22D respectively show the locking device 410 in unlocked and locked configurations.

The support plate 214 defines a cavity 214C that is sized to receive a latch 411 therein. The latch 411 is pivotably movable relative to the support plate 214 about a pin 412. A biasing member 413, such as a spring, is engaged to both of the support plate 214 and the latch 411 to bias the latch 411 in the locked configuration. The latch 411 may have a portion protruding downwardly from a bottom face of the support plate 214 to facilitate engagement by a user. The bottom wall of the container 281 of the golf ball washing device 280 includes a notch 281A that extends from a bottom face of the bottom wall towards the bristle cartridge. As depicted, in the unlocked configuration, the notch 281A and the cavity 214C of the support plate 214 are offset from one another. As the male and female members 401, 402 are rotated one relative to the other along direction D8 to engage the tabs in the closed sections of the slots, the cavity 214C and the notch 281A become in register. At some point, a locking end 411A of the latch 411 becomes in register with the notch 281A and the biasing member 413 causes the locking end 411A to extend into the notch 281A thereby circumferentially locking the golf ball washing device 280 to the support plate 214. This prevents the disengagement of the tabs from the slots. To separate these two components, a user may push on a pushing end 411B of the latch 411 to disengage the locking end 411A from the notch 281A thereby allowing the relative rotation of these components to separate the golf ball washing device 280 from the support plate 214. In some embodiments, the latch 411 may be replaced by a push button, a locking pin, and so on. Any means for locking the golf ball washing device 280 to the support 214 are contemplated without departing form the scope of the present disclosure.

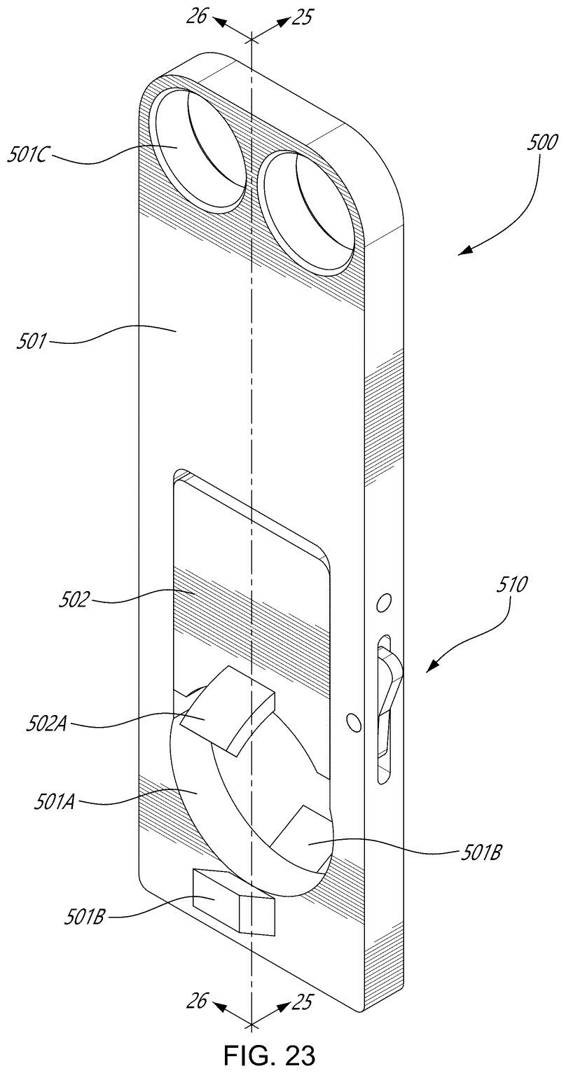

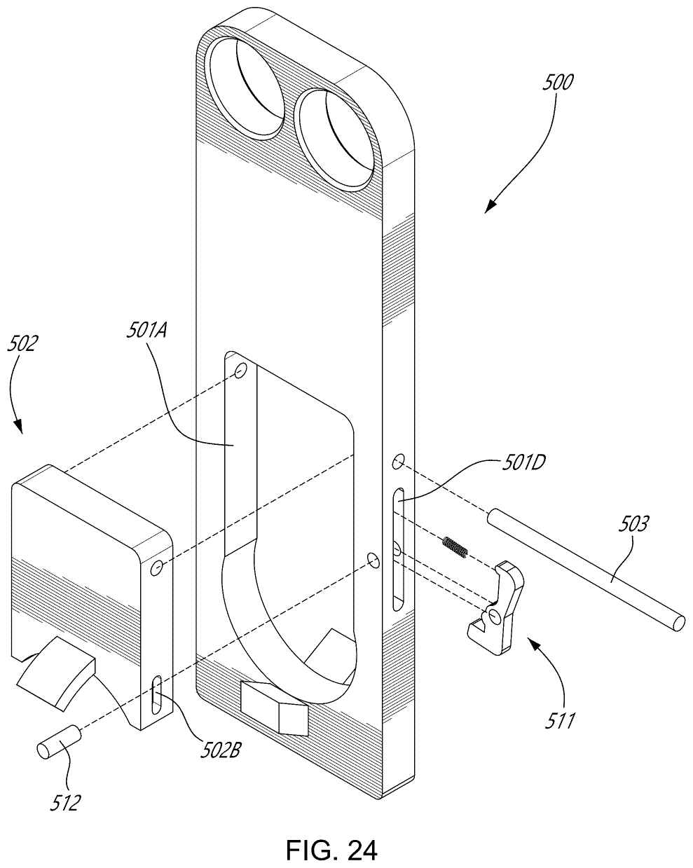

Referring now to FIGS. 23 to 26, the ball holding device 500 is described in greater detail. The ball holding device includes handle 501 to be engaged by a hand of the user. The handle 501 defines an aperture 501A sized to receive both of the ball B and a movable flap 502 pivotably engaged to the handle 501 via a pin 503. The movable flap 502 and the handle 501 define retaining tabs 502A, 501B that cooperate with each other to at least partially enclose the ball B. A total of four tabs, two for the handle and two for the flap may be used, but other numbers are contemplated. The handle 501 defines apertures 501C to receive fingers of the hand of the user and for attaching the ball holding device to the golf ball washing device 280. These apertures may be omitted in some configurations. Only one aperture or slot may be used in some embodiments.

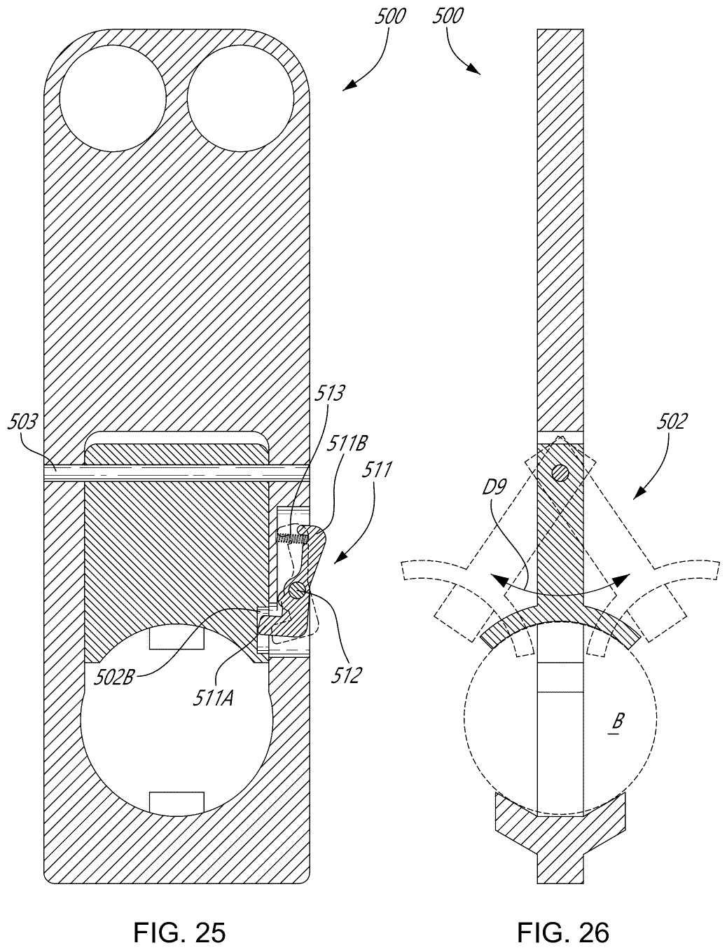

The ball holding device 500 includes a ball locking mechanism 510 that includes a latch 511 received within a recess 501D of the handle 501. The latch 511 is pivotably movable relative to the handle 501 about a pin 512. As shown in FIG. 25, the latch 511 is movable between locked and unlocked positions. The recess 501D communicates with the apertures 501A of the handle 501. The movable flap defines a notch 502B. A biasing member 513, such as a spring, biases the latch 511 in the locked position. The latch 511 has a locking end 511A receivable within the notch 502B of the movable flap 502. A user may push on a pushing end 511B of the latch 511 to move the latch 511 from the locked position shown in solid lines in FIG. 25 to the unlocked position shown with dashed lines in FIG. 25. In the locked position, the locking end 511A extends into the apertures 501A and into the notch 502B of the movable flap 502 thereby preventing movements of the movable flap 502 relative to the handle 501. When the user pushes on the pushing end 511B of the latch 511, the locking end 511A is retracted outside the notch 502B thereby allowing the movable flap 502 to move along direction D9 as illustrated in FIG. 26. The movements of the movable flap 502 allows to insert or retrieve the ball B. Hence, the movable flap 502 moves between a ball-holding position depicted with solid lines in FIG. 26 and ball-releasing positions depicted with dashed lines in FIG. 26. In the ball-holding position, the movable flap 502 is received in the aperture 501A and is pivoted away from the aperture in the ball-releasing position.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

In a variant, a method of installing a golf ball washing device, such as 8, to a trolley such as 1, may include fixing a trolley-fastening member, such as 11, to a frame of the trolley; adjusting at least one joint to position and orient a device holder, such as 12, to have a plane thereof generally parallel to a ground, and engaging the golf ball washing device to the device holder 12, such that the golf ball washing device is generally upright and levelled relative to the ground. Herein, expressions “generally” and “substantially” may include variations of between ±10 degrees inclusively from vertical.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A support for attaching a golf ball washing device to a golf trolley supporting a golf bag, comprising:
a fastening member configured for being removably secured to a frame member of the golf trolley or to the golf bag;
a device holder configured for supporting the golf ball washing device; and
a positioning mechanism operatively connected to both of the device holder and the fastening member, the positioning mechanism including arms pivotably engaged to one another and operable to move the device holder relative to the fastening member about a plurality of degrees of freedom.

2. The support of claim 1, wherein the arms include:
a first arm extending from a first proximal end pivotably mounted to the fastening member to a first distal end;
a second arm extending from a second proximal end pivotably mounted to the first distal end of the first arm to a second distal end mounted to the device holder.

3. The support of claim 2, wherein the fastening member extends around a longitudinal axis being parallel to the frame member.

4. The support of claim 3, wherein the first proximal end is rotatable relative to the fastening member about a first axis being transverse to the longitudinal axis.

5. The support of claim 4, comprising a first anti-rotation feature between the first proximal end and the fastening member to selectively prevent rotation between the first arm and the fastening member.

6. The support of claim 3, wherein the second proximal end of the second arm is rotatable relative to the first distal end of the first arm about a second axis being transverse to both of the first arm and the second arm to vary an angle defined between the first arm and the second arm.

7. The support of claim 6, comprising a second anti-rotation feature between the first distal end and the second proximal end to selectively prevent rotation between the first arm and the second arm about the second axis.

8. The support of claim 3, wherein the first arm has a first arm section and a second arm section mounted coaxially to the first arm section, the first arm section rotatable relative to the second arm section.

9. The support of claim 1, wherein the device holder includes a support plate having a support flange extending peripherally around an aperture sized to receive the golf ball washing device therethrough.

10. The support of claim 1, wherein the fastening member includes a vertical tab receivable within an opening of the golf bag.

11. The support of claim 10, wherein the arms include a first plate and a second plate pivotally engaged to the first plate for rotation about a roll axis, the second plate pivotally engaged to the device holder for rotation about a pitch axis transverse to the roll axis.

12. The support of claim 1, wherein the fastening member is a strap extending around the golf bag, the device holder secured to the golf bag via the strap.

13. The support of claim 12, wherein the strap is received through slots defined by device holder.

14. An assembly comprising:
a golf ball washing device having a container enclosing bristles for washing a golf ball; and
a support for securing the golf ball washing device to a golf trolley or a golf bag, the support having:
a fastening member configured for being removably secured to a frame member of the golf trolley or to the golf bag;
a device holder configured for supporting the golf ball washing device; and
a positioning mechanism operatively connected to both of the device holder and the fastening member, the positioning mechanism including arms pivotably engaged to one another and operable to move the device holder relative to the fastening member about a plurality of degrees of freedom; and
a locking mechanism for releasably securing the golf ball washing device to the device holder, the locking mechanism having a male member defined by one of the container of the golf ball washing device and the device holder of the support and a female member defined by the other of the container of the golf ball washing device and the device holder of the support, the locking mechanism having a locked configuration in which the male member engages and is locked into the female member and an unlocked configuration in which the male member is detachable from the female member.

15. The assembly of claim 14, wherein the male member includes tabs receivable within slots of the male member, the slots having open sections and closed sections, the tabs receivable into the slots via the open sections via an axial translation of the golf ball washing device relative to the device holder, the tabs slidably receivable into the closed sections of the slots via rotation of the golf ball washing device relative to the device holder.

16. The assembly of claim 15, comprising a locking device to lock the locking mechanism in the locked configuration, the locking device including a latch pivotally mounted to the device holder, the latch having a locking end receivable into a notch defied by the golf ball washing device, wherein the locking end of the latch is in register with the notch upon the tabs received into the closed sections of the slots.

17. The assembly of claim 14, further comprising a ball holding device having:
a handle defining an aperture; and
a movable flap pivotally engaged to the handle, the movable flap movable between a ball-holding position in which the movable flap is received in the aperture and a ball-releasing position in which the movable flap is pivoted away from the aperture, the ball holding device configured to at least partially enclose the golf ball in the ball-holding position.

18. The assembly of claim 17, wherein both of the handle and the movable flap defines tabs for holding the golf ball.

19. The assembly of claim 17, further comprising a latch for locking the movable flap relative to the handle in the ball-holding position.

20. The assembly of claim 17, comprising a retractable rope, the golf ball washing device secured to the golf ball washing device or the support via the retractable rope.
